(19) United States
(12) Patent Application Publication
(10) Pub. No.: US 2016/0301220 A1
(43) Pub. Date: Oct. 13, 2016

(54) Controlling a Charging Device by Means of a Storage Battery

(71) Applicant: HILTI AKTIENGESELLSCHAFT, Schaan (LI)

(72) Inventors: Klaus HAUSER, Schwabmuenchen (DE); Benedikt BECKERT, Augsburg (DE)

(73) Assignee: Hilti Aktiengesellschaft, Schaan (LI)

(21) Appl. No.: 15/036,719

(22) PCT Filed: Nov. 18, 2014
(86) PCT No.: PCT/EP2014/074831

§ 371 Date: May 13, 2016

(30) Foreign Application Priority Data
Nov. 18, 2013 (EP) 13193232.9

(51) Int. Cl. H02J 7/00

(52) U.S. Cl. CPC H02J 7/007; H02J 2007/0096

(57) ABSTRACT

A method for controlling a charging process in a system containing a storage battery and a charging device is disclosed. The method includes the step of transmitting a control signal from the storage battery to the charging device, which can be connected to the storage battery, in order to adjust at least one charging parameter of the charging device.

This application claims the priority of International Application No. PCT/EP20141074831, filed Nov. 18, 2014, and European Patent Document No. 13193232.9, filed Nov. 18, 2013, the disclosures of which are expressly incorporated by reference herein.

### BACKGROUND AND SUMMARY OF THE INVENTION

The present invention relates to a method for controlling a charging process in a system comprising a storage battery and a charging device.

For charging a storage battery, it is connected to a charging device so that the storage battery can be re-supplied with electrical current or electrical voltage for storing in the storage battery.

In systems known to date comprising a storage battery and a charging device, the current or voltage is provided by the charging device to the storage battery by means of so-called characteristic curves, which are stored in tables in the charging device, i.e., in a control unit in the charging device. By means of these tables and a corresponding identifier of the connected storage battery, the charging device is able to provide the matching values, i.e., size, duration, etc., of the current and voltage respectively to the connected storage battery.

Such a system consisting of a storage battery and the associating charging device is disclosed by German patent specification DE 10 2010 041 510. This document regarding prior art discloses an electric energy storage system comprising a chargeable storage battery and a charging device for charging the storage battery. The storage battery thereby comprises an information memory with charging information, which is allocated to the various charging types, and the charging device is designed to control the charging of the storage battery according to one of the charging types depending on the allocated charging information from the information memory.

However, a disadvantage of the already existing system comprising a storage battery and charging device is that, as disclosed in DE 10 2010 041 510, a user of the system is tied to a limited selection of predetermined charging processes or charging routines that are stored in the storage battery to adjust the entire charging process. As a result, there is only a slight degree of flexibility when charging the storage battery.

In addition, the existing system comprising a storage battery and charging device has the problem that older charging devices can no longer charge new storage batteries using new and much more complex charging processes and algorithms, or only do so with major technical effort.

It is therefore an object of the present invention to provide an improved method for controlling a charging process in a system comprising a storage battery and a charging device, by means of which the aforementioned problems are eliminated and an efficient charging process is made possible.

Accordingly, a method is provided for controlling a charging process in a system comprising a storage battery and a charging device.

According to the invention, the transmission of a control signal is provided from the storage battery to the charging device that is connectable to the storage battery for adjusting at least one charging parameter of the charging device. Efficient controlling of the charging process is hereby achieved by the situation-appropriate setting of at least one charging parameter on the storage battery-side. The charging parameters to be adjusted may involve among other things the charging current or the charging voltage.

According to another advantageous embodiment of the present invention, it may be provided that the adjustment of the at least one charging parameter occurs according to at least one charging routine stored in the storage battery. The charging routine thereby essentially comprises characteristic curves, such as a current-voltage characteristic curve stored in the storage battery. By means of the charging routine, the storage battery is able to check the charging process and to correspondingly modify the charging current and/or the charging voltage in the event of any deviations from the charging routine or from a characteristic curve. It is hereby even possible that the storage battery completely terminates the charging process given a certain deviation from the charging routine or from a characteristic curve.

To respond appropriately to the influences of the temperature of the storage battery in a corresponding and situation-appropriate manner during a charging process or during the charging routine, it may be advantageous that the adjustment of the at least one charging parameter occurs dependent on at least one temperature value of the storage battery. Accordingly, for a low temperature of the storage battery, one can reduce the value of the at least one charging parameter. Thus, for example, a low charging current is applied to the storage battery when the temperature of the storage battery is correspondingly low.

According to another advantageous embodiment of the present invention, it may be provided that the transmitting of the control signal to adjust the at least one charging parameter of the charging device occurs in regular time intervals. One can hereby ensure that the situation-appropriate adjusting of the at least one charging parameter occurs regularly on the storage battery-side for the efficient controlling of the charging process and can thereby (if necessary) be continually adjusted. Alternatively, it is also possible however that the adjusting of the at least one charging parameter of the charging device does not occur in regular time intervals, but in irregular time intervals, i.e., based on situation dependent requirements. Such situation-dependent requirements may be for example terminating (i.e., following a trend) or suddenly occurring emergencies in the form of overheating or excessive cooling of the storage battery.

So that one can respond to the influences of the storage battery temperature during a charging process in a corresponding and situation appropriate manner, it is possible that the length of the time intervals occurs dependent on at least one temperature value of the storage battery. It is hereby possible that the length of the time intervals in critical temperature ranges, i.e., very low or very high temperatures, is decreased or increased.

The present invention is explained in greater detail in regard to advantageous embodiments.

### BRIEF DESCRIPTION OF THE DRAWINGS

FIG. 1 depicts a system comprising a storage battery and a charging device for using the method according to the invention, and

FIG. 2 depicts a representation of a charging profile with the charging current dependent on the storage battery temperature.

### DETAILED DESCRIPTION OF THE DRAWINGS

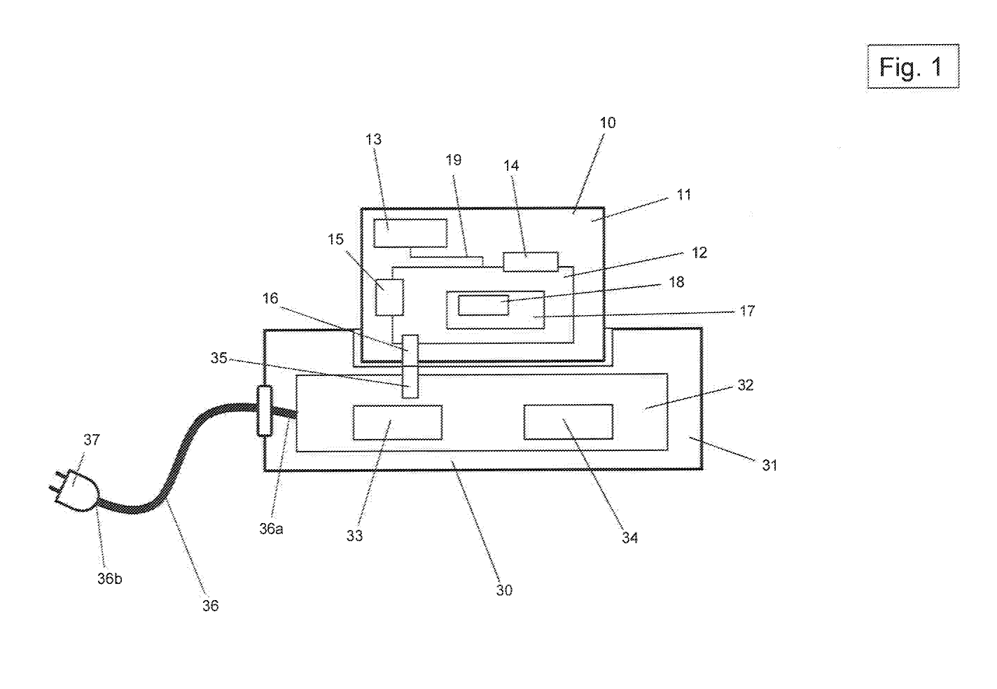

FIG. 1 depicts a system 1, which comprises a storage battery 10 and a charging device 30.

Storage battery 10 comprises to this end a housing 11, a control unit 12, a temperature sensor 13, a voltage sensor 14, a current sensor 15, and an interface 16 to charging device 30.

Control unit 12 of storage battery 10 is positioned in housing 11 of storage battery 10 and comprises in turn a microprocessor 17 as well as a memory unit 18. A charging routine specific to storage battery 10 is stored on memory unit 18. The charging routine thereby comprises characteristic curves, such as a current-voltage characteristic curve for example. In addition, memory unit 18 also comprises another characteristic curve diagram, in which at least one temperature value of storage battery 10 is added as a parameter to the current-voltage characteristic curve. Various temperature-relevant charging processes or charging routines are hereby stored in storage battery 10.

Microprocessor 17 along with voltage sensor 14 and current sensor 15 serve to process or to monitor the charging procedure. Voltage sensor 14 serves in particular to monitor the charging voltage transmitted by charging device 30. Current sensor 15 serves in particular to monitor the charging current transmitted by charging device 30.

Via interface 16 designed as an electrical contact, which represents a removable connection between storage battery 10 and charging device 30, control unit 12 transmits control signals to charging device 30. By means of these control signals, instructions are sent to charging device 30 in regard to the temperature related adjustment of at least one charging parameter. The charging parameter is the charging current or the charging voltage, for example.

Temperature sensor 13 is positioned in housing 11 of storage battery 10 and measures the temperature of storage battery 10. Temperature sensor 13 is connected via a connection cable 19 to control unit 12. The temperature values transmitted to control unit 12 serve to select the situation-appropriate charging routine. The respectively measured temperature value is hereby assigned to the corresponding current-voltage characteristic curve stored on control unit 12, to thereby select the charging current or the charging voltage matching the respective temperature of storage battery 10 and to request it from charging device 30.

Charging device 30 comprises a housing 31, in which a charging regulator 32 with a current regulator 33 and a voltage regulator 34 is positioned. Current regulator 33 serves to provide a charging current and voltage regulator 34 serves to provide a charging voltage. Voltage regulator 34 and current regulator 33 serve as voltage and current limiters respectively for fixed currents.

Housing 31 of charging device 30 also comprises an interface 35 to storage battery 10 as well as a mains cable 36 with a first end 36a and a second end 36b. First end 36a of mains cable 36 is connected through housing 31 of charging device 30 to charging regulator 32. Second end 36b of mains cable 36 has a connection 37 for a non-depicted mains current source.

As also depicted in FIG. 1, storage battery 10 is removably connected to charging device 30 in such a manner that interface 16 of storage battery 10 is connected to interface 35 of charging device 30. Via this connection, information signals as well as charging parameters in the form of charging current and charging voltage are exchanged between storage battery 10 and charging device 30.

Storage battery 10 is configured for using the method according to the invention in such a manner that it primarily monitors, controls, and regulates the charging procedure independently. Charging device 30 thereby essentially functions only as a pure command receiver, which according to the instructions of storage battery 10 emits a corresponding charging current to storage battery 10 or applies a charging voltage to storage battery 10.

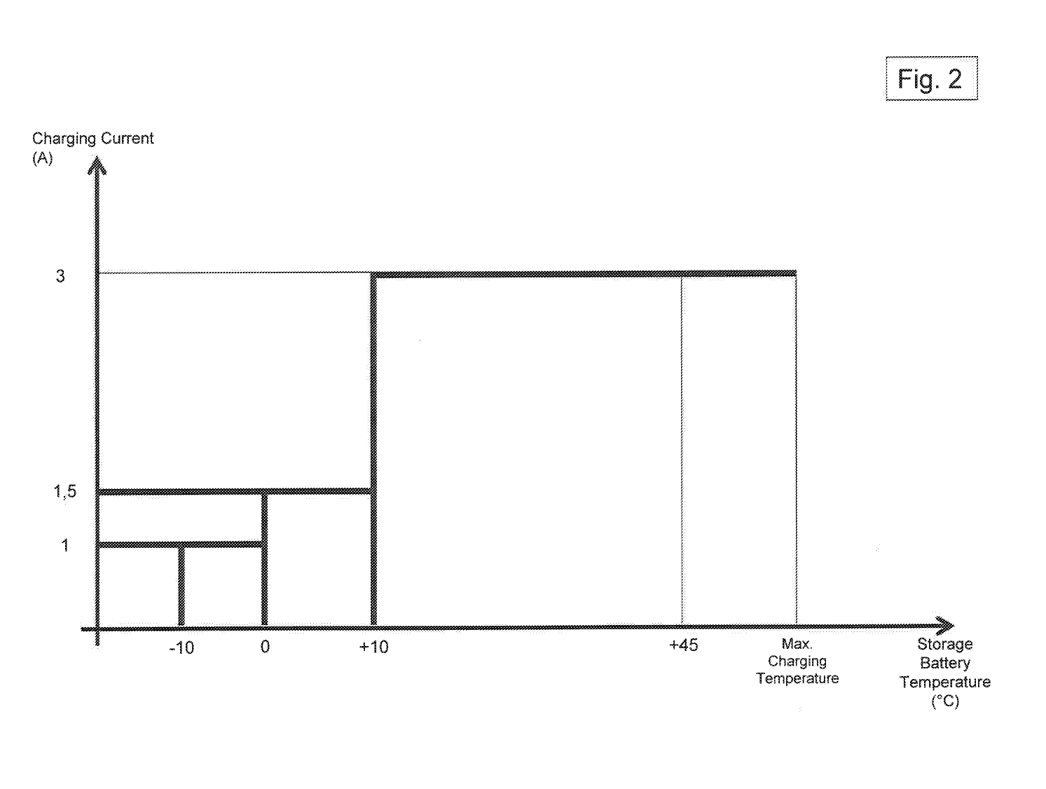

As depicted in FIG. 2, storage battery 10 is able to adjust the charging current to the respective temperature value, i.e., at a temperature of storage battery 10 of −10° to 0° C., a charging current of 1 A is applied. In a temperature range of 0° to +10° C., the charging current is 1.5 A. If the storage battery temperature lies in a range between +10″ and +45° C. the charging current is 3 A.

To this end, control unit 12 of storage battery 10 monitors in regular time intervals the charging process using the charging routine stored and selected on control unit 12. As already described earlier, the temperature values measured by temperature sensor 13 are included to select the suitable charging routine for the respectively measured temperature of storage battery 10. To this end, control unit 12 compares the charging current transmitted by charging device 30 or the charging voltage transmitted by charging device 30 in relation to the currently measured storage battery temperature against the corresponding characteristic curves belonging to the charging routine. Given a certain deviation of the charging current or the charging voltage from the respective characteristic curve, control unit 12 intervenes in the charging process in a regulating manner by control unit 12 requesting a modified charging current or a modified charging voltage via interface 16 from charging device 30. In regard to the modified charging current or the modified charging voltage, these pertain to the charging current or the charging voltage that are correct according to the stored temperature-relevant characteristic curves.

As also described precedingly, voltage regulator 34 and current regulator 33 of charging device 30 each serve as voltage or current limiters respectively. Upon requesting a certain charging current or charging voltage from storage battery 10, charging device 30 interprets the control signal transmitted to this end by storage battery 10 and then transmits the respective charging voltage or charging current. Operating as voltage and current limiters respectively, voltage regulator 34 and current regulator 33 of charging device 30 thereby monitor that the correct charging voltage or charging current is transmitted to storage battery 10.

In addition, charging device 30 sends a corresponding measurement signal for control purposes to storage battery 10 to inform and warn storage battery 10 in a timely manner about a relatively high charging voltage or a relatively high charging current. By means of this measurement signal sent by charging device 30, storage battery 10 is able to detect errors in the request for a matching charging voltage or a matching charging current and to correct it if applicable. Such errors may be for example that an excessively high charging current is requested from storage battery 10 or an atypical loss. By means of voltage sensor 14 and current sensor 15 positioned in storage battery 10, storage battery 10 can measure a comparison value to the requested charging voltage or the requested charging current, and in the event of a corresponding deviation, it can effect another adjustment or also as complete discontinuation of the charging process, if applicable.

1.-5. (canceled)

6. A method for controlling a charging process, comprising the steps of:
transmitting a control signal from a storage battery to a charging device that is connected to the storage battery and adjusting at least one charging parameter of the charging device by the control signal.

7. The method according to claim 6, wherein the adjusting occurs corresponding to at least one charging routine stored in the storage battery.

8. The method according to claim 6, wherein the adjusting occurs dependent on at least one temperature value of the storage battery.

9. The method according to claim 6, wherein the transmitting occurs in regular time intervals.

10. The method according to claim 9, wherein a length of the regular time intervals occurs dependent on at least one temperature value of the storage battery.

11. The method according to claim 6, wherein a charging routine specific to the storage battery is stored on a memory in the storage battery.
